(19) United States
(12) Patent Application Publication
(10) Pub. No.: US 2016/0226867 A1
(43) Pub. Date: Aug. 4, 2016

(54) CLOUD-BASED BIOMETRIC ENROLLMENT, IDENTIFICATION AND VERIFICATION THROUGH IDENTITY PROVIDERS

(71) Applicant: IMAGEWARE SYSTEMS, INC., San Diego, CA (US)

(72) Inventor: David Harding, Portland, OR (US)

(21) Appl. No.: 14/985,872

(22) Filed: Dec. 31, 2015

Related U.S. Application Data
(63) Continuation-in-part of application No. 14/044,757, filed on Oct. 2, 2013.
(60) Provisional application No. 61/708,945, filed on Oct. 2, 2012.
(60) Provisional application No. 62/099,108, filed on Dec. 31, 2014.
(60) Provisional application No. 62/099,111, filed on Dec. 31, 2014.
(60) Provisional application No. 62/099,114, filed on Dec. 31, 2014.

(51) Int. Cl. H04L 29/06

(52) U.S. Cl. CPC H04L 63/0861; H04L 63/0853

(57) ABSTRACT

A system and method for cloud-based biometric enrollment, identification and verification are disclosed. More specifically, a cloud-based system and method is used for enrollment of biometric templates. An identity provider serves as an interface between a service provider and a biometric engine. Identity provider employs an open standards protocol such as Security Assertion Markup Language (SAML) or OpenID to exchange authentication data between the service provider and the biometric engine. Service provider employs embedded and/or externally attached hardware in client computing devices for capturing biometric probes and client identity information. Subsequently, biometric engine generates biometric templates from the captured biometric probes and enrolls biometric templates and client identity information for use in identification and authentication in a subsequent transaction.

### CROSS-REFERENCE TO RELATED APPLICATIONS

The present application claims priority to and is a continuation-in-part of U.S. patent application Ser. No. 14/044,757, filed on Oct. 2, 2013, and entitled “Systems and Methods for Conducting Cloud-Based Biometric Authentication,” which claims priority to U.S. Provisional Patent Application No. 61/708,945, filed on Oct. 2, 2012, the disclosures of which are all herein incorporated by reference in their entireties. The present application also claims priority to U.S. Provisional Patent Application No. 62/099,108, filed on Dec. 31, 2014, and entitled “Cloud-Based Biometric Enrollment Through Identity Providers;” U.S. Provisional Patent Application No. 62/099,111, filed on Dec. 31, 2014, and entitled “Cloud-Based Biometric Identification Through Identity Providers;” and U.S. Provisional Patent Application No. 62/099,114, filed on Dec. 31, 2014, and entitled “Cloud-Based Biometric Verification Through Identity Providers,” the disclosures of which are all herein incorporated by reference in their entireties.

### BACKGROUND OF THE INVENTION

1. Field of Invention

The present invention relates generally to biometrics and more particularly to cloud-based biometric enrollment, identification, and verification through an identity provider.

2. Description of Related Art

Cloud computing refers to anything that involves delivering hosted services over the Internet. The term “cloud” often refers to the Internet and more precisely to some datacenter full of servers that is connected to the Internet. A cloud can be a wide area network (WAN) like the Internet or a private, national, or global network. The term can also refer to a local area network (LAN) within an organization. As used herein, a “cloud” is any communications network.

A service provider operating in the cloud may be operatively coupled with a security system for providing biometric authentication. Examples of service providers include, but are not limited to a variety of cloud-based applications, social networking, email, hosting (e.g., documents, spreadsheets, images, videos), data backup and storage, banking and financial services, health care, government, webpages, and online retailers, among others. Examples of security systems include a biometric engine that ensures only valid individuals gain access to controlled areas or computing resources.

The integration of security systems with service providers often requires the development of complex and specific communication protocols to exchange authentication data. This may complicate the interoperability between security systems and service providers, while increasing development costs and affecting the authentication performance.

Accordingly, it is desirable to standardize the interfaces between security and service provider systems for allowing faster, cheaper, and more reliable integration.

### SUMMARY OF THE INVENTION

The present invention overcomes these and other deficiencies of the prior art by integrating a biometric engine with one or more service providers. An identity provider operating between the biometric engine and the service providers is utilized. The identity provider may implement authentication protocols such as Security Assertion Markup Language (SAML) and OpenID, among others.

According to an embodiment of the invention, a system for allowing biometric enrollment, identification and verification comprises one or more client computing devices operatively coupled with one or more service providers, one or more identity providers and one or more biometric engines supported in the cloud. The client computing devices are capable of capturing different client biometric probes for supporting multimodal biometric enrollment. The service provider exchanges authentication data with a biometric engine through the identity provider, where this identity provider uses one or more open standard authentication protocols such as SAML and OpenID. The biometric engine includes a query router, one or more query engines, one or more data caches, and a demographic database. The service provider requests biometric enrollment of one or more clients through the biometric engine for allowing or approving a transaction initiated by a client.

According to another embodiment of the invention, a method for biometric enrollment comprises a service provider requesting client enrollment to the biometric engine through the identity provider. The identity provider requests capture of biometric probes and client identity information from the client computing device. Client computing devices employ embedded and/or externally attached hardware for capturing one or more biometric probes and client identity information. Each biometric probe is associated with a different biometric modality including, but not limited to fingerprint, iris, face, and voice, among others. Subsequently, a client computing device submits the biometric probes and client identity information to the identity provider. Then, the identity provider submits the captured biometric probes and client identity information to the biometric engine for generation of biometric templates. The biometric engine employs one or more query routers and one or more query engines for generating biometric templates from biometric probes and then stores the templates in one or more biometric data caches. Similarly, query router stores client identity information in one or more demographic databases. Subsequently, the biometric engine returns a status of enrollment, e.g., fail or successful enrollment, to the identity provider. Then, the identity provider creates and submits one or more responses. Afterwards, if the enrollment was successful, service provider proceeds to verify and/or identify a client, i.e., person, using the enrolled biometrics probes for a subsequent transaction.

The implementation of the identity provider with open source communication protocols provides a standard interface between the service provider and the biometric engine, thereby integrating the service provider and the biometric engine. This integration supports a fast and reliable client biometric enrollment as required by the service provider.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates the biometric engine;

FIG. 2 illustrates a system for cloud biometric enrollment where an identity provider is used to exchange data between a service provider and a biometric engine according to an embodiment of the invention;

FIG. 3 illustrates a block diagram of a client computing device according to an embodiment of the invention;

FIG. 4 illustrates a method for cloud-based biometric enrollment that includes an identity provider as the interface between a service provider and a biometric engine according to an embodiment of the invention;

FIG. 5 illustrates a method for cloud-based biometric identification that includes an identity provider as the interface between a service provider and a biometric engine according to an embodiment of the invention; and

FIG. 6 illustrates a method for cloud-based biometric verification that includes an identity provider as the interface between a service provider and a biometric engine according to an embodiment of the invention.

### DETAILED DESCRIPTION OF EMBODIMENTS

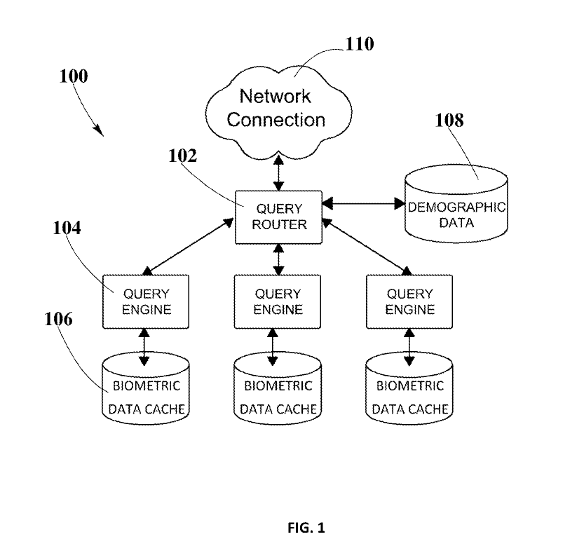

Further features and advantages of the invention, as well as the structure and operation of various embodiments of the invention, are described in detail below with reference to the accompanying FIGS. 1-6. Other embodiments may be used and/or other changes may be made without departing from the spirit or scope of the present disclosure. The illustrative embodiments described in the detailed description are not meant to be limiting of the subject matter presented here.

As used herein, certain terms are defined as follows:

“Biometric capture” refers to using a biometric input device or system to acquire biometric data from an individual in the form of images, templates, or other form;

“Biometric data” refers to information that may be used to verify or identify a person based on physical traits, attributes, or behaviors. Biometric data includes, but is not limited to images of fingerprints, faces, irises, and any binary data generated by biometric capture algorithms;

“Biometric fusion score” refers to any probability score that uses multiple biometric inputs or methods of processing to improve performance. For example, matching scores from multiple modalities are normalized and combined (e.g., fused) to create a single probability score;

“Biometric probe” refers to any captured biometric data that may be used to compare with or matched against one or more prior enrolled biometric templates;

“Biometric template” refers to a digital record of distinct characteristics that have been extracted by a biometric algorithm from biometric data associated with a person;

“Biometric verification” refers to a process of using biometric authentication to validate the identity of a person;

“Client” refers to a person or user having a computing device capable of receiving and responding to interactive messages, and capable of capturing one or more biometric modalities—a biometric client can also refer to the computing device itself;

“Identifier” refers to any unique credential such as a username, password, and/or other identifying information that may be used during authentication of a client;

“Query engine” refers to a computer system capable of comparing biometric probes and biometric templates and may return a biometric score or a biometric fusion score; and

“Query router” refers to software and/or hardware that may manage and queue biometric verification queries in a query engine.

[Transition Paragraph]

FIG. 1 illustrates a biometric engine 100 according to an embodiment of the invention. Biometric engine 100 comprises a query router 102, one or more query engines 104, and one or more biometric data caches 106 associated with each query engine 104. Query router 102, although optional, is operatively connected to a suitable network connection 108, the identification and implementation of which is apparent to one of ordinary skill in the art. For example, network connection 108 can comprise a local area network (LAN), a virtual private network (VPN), a wireless area network (WAN), or any combination thereof to communicate to an interactive messaging system service via the Internet. Network connection 108 provides an operational connection with a client or a service provider that may use the biometric engine 100 as an identity provider.

Query router 102 includes software programmed according to the embodiments described herein and executed on a processor. Query router 102 can be associated with an optional demographic database 110 for storing demographic data, such as gender, age, or even personal information, such as name and telephone number, among others, of a client. The identification and implementation of the demographic database 110 is apparent to one of ordinary skill in the art. In another embodiment, demographic database 108 may be operated from a service provider infrastructure, in which case, biometric engine 100 does not directly associate the demographic data with biometric data when performing biometric authentication, thereby allowing anonymous biometric authentication through the use of tokens that can be used to isolate the specific biometric data for matching and/or analysis.

The demographic database 110 (and any other database discussed herein) may implement a database management systems (DBMS) such as, but not limited MySQL, PostgreSQL, SQLite, Microsoft SQL Server, Microsoft Access, Oracle, SAP, dBASE, FoxPro, IBM DB2, LibreOffice Base, FileMaker Pro, MongoDb, and/or any other type of database software that organizes collections of data.

Query router 102 is in communication with one or more query engines 104 through a suitable computer network, the identification and implementation of which is apparent to one of ordinary skill in the art. In an embodiment of the invention, each query engine 104 is implemented on a computer having installed thereon a suitable operating and biometric software according to the embodiments described herein. All query engines 104 can be implemented on the same computer or distributed among multiple computers. Each query engine 104 is associated with a biometric data cache 106, the implementation of which is also apparent to one of ordinary skill in the art. Each query engine 104 can be adapted to process a single biometric modality or multiple biometric modalities. In an embodiment of the invention, query engines 104 convert biometric data into templates for storage in biometric data cache 106 at enrollment. In another embodiment of the invention, the query engines 104 receive biometric templates created elsewhere, for example, from a biometric capture device. The query engines 104 create (or receive) biometric probes to compare against enrolled biometric templates at verification time.

In operation, query router 102 receives a call, such as a service-oriented architecture (SOA) call, from a client's device or a server associated with a service provider to verify the authenticity of a client's identity. The call includes user information that may be used by the biometric engine 100 to authenticate the biometric client. Information provided in the call may include, for example, demographic information, such as age, gender, city, and the like; or personal information, such as a name, a username, an email, a phone, or any information associated with the user that may be used by the biometric engine 100 for authentication. Alternatively, the call may be anonymous, i.e., without knowledge of biographic, demographic or otherwise identifying information. Information provided may also include a biometric probe that is to be compared against biometric templates previously stored in the biometric data caches 106. Query router 102 may route requests to the appropriate query engines 104, depending on the biometric type or work load on the query engines 104. Query router 102 monitors the activities of the query engines 104 and may combine their responses (success/fail) into a single SOA response that may be sent back to the client's device or service provider.

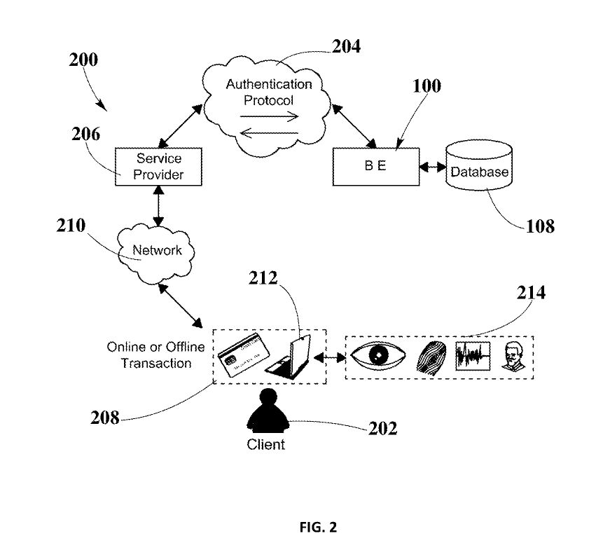

FIG. 2 depicts a system 200 for cloud-based biometric enrollment according to an embodiment of the invention, where one or more clients 202 enroll their identities and submit biometric probes through the use of one or more client computing devices 212 in communication with a biometric engine 100 in the cloud 210. According to some aspects of this embodiment, system 200 includes an identity provider 204 which uses one or more authentication protocols as an interface between one or more service providers 206 and biometric engine 100 for providing biometric identification.

In system 200, a transaction 208 may include one or more clients 202 making an online purchase of one or more items or services over the internet or cloud. For example, client 202 may enter a website using a computer for making a particular purchase, in which case, the website may not provide biometric identification or verification. In another embodiment, client 202 may make an offline purchase, for example, when swiping a credit card at a point of sale terminal to purchase an item or service.

In order to complete transaction 208, client 202 is required to be identified, in which case, service provider 206 requests the identification of client 202 for approving transaction 208. For example, service provider 206 may be a bank, an online retailer, a store, or a service company requiring the authentication of client 202 who is using his credit card for acquiring goods or services.

Client 202 initiates transaction 208 in the cloud through a suitable network connection 210 with service provider 206. In another embodiment, network connection 210 may include intranets, local area networks (LAN), virtual private networks (VPN), and wireless area networks (WAN), among others.

Identity provider 204 includes an authentication module (not shown in FIG. 2) operating in the cloud, and employs one or more authentication protocols for exchanging authentication and authorization data between service provider 206 and biometric engine 100. In one embodiment, identity provider 204 employs SAML for allowing authentication and secure communication between service provider 206 and biometric engine 100. In another embodiment, identity provider 204 employs OpenID for allowing the authentication and secure communication between service provider 206 and biometric engine 100. By using open source authentication protocols, the implementation and identification of which are apparent to one of ordinary skill in the art, identity provider 204 allows the integration of biometric engine 100 as a plug-in solution to provide biometric authentication to a plurality of service providers 206. Identity provider 204 submits client 202 identifiers such as username and password, and requests biometric identification of client 202 in biometric engine 100.

One or more client computing devices 212 are operatively coupled with biometric engine 100 and identity provider 204 through network connection 210. Client computing devices 212 are used to capture biometrics of client 202. Examples of client computing devices 212 include smartphones, tablets, and PDAs, among others.

In one embodiment of the invention, client computing devices 212 support multimodal biometric 214 for capturing a plurality of biometric probes such as face, fingerprint, iris, and/or voice, among others. Client computing devices 212 submit one or more biometric probes to biometric engine 100 for identification purposes. According to some aspects of this embodiment, biometric engine 100 converts these biometric probes into corresponding biometric templates for matching against previously stored biometric templates. Alternatively, the biometric probes have been converted to templates prior to arriving at the biometric engine 100. Matching results in individual scores for each type of biometric template being compared, for example, one score is generated for the iris comparison, and another score for the voice comparison. The biometric scores generated for the different modalities of biometric probes may be combined into a single fusion biometric score that can be used for validating the biometric authentication.

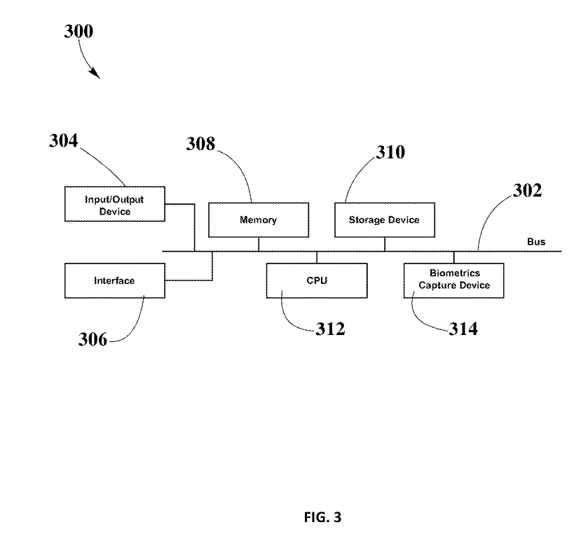

FIG. 3 illustrates a block diagram of example components in a client computing device 300, in which one or more embodiments of the present invention may operate. Client computing device 300 may be a laptop computer, a desktop computer, a smartphone, a tablet, a game console, a set-top box, and/or another type of processor-controlled device that may receive, process, and/or transmit digital data, among others. Client computing device 300 operates within a system for providing cloud biometric verification. Client computing device 300 includes a bus 302, an input/output device 304, an interface 306, a memory 308, a storage device 310, a central processing unit (CPU) 312, and one or more biometrics capture devices 314. In another embodiment, client computing device 300 may include additional, fewer, different, and/or differently arranged components than are illustrated in FIG. 3.

Bus 302 allows components within client computing device 300 to communicate with each other. Input/output device 304 includes peripherals and/or other mechanisms that enable a user to input information to client computing device 300, including for example a keyboard, a mouse, a button, a touch screen, voice recognition, and biometric mechanisms, among others. Input/output device 304 also includes a mechanism that may output information to the user of client computing device 300 such as, for example, a display, a light emitting diode (LED), and a speaker, among others. Interface 306 includes mechanisms that enable client computing device 300 to communicate with other client computing devices 300 and/or systems through network connections. Network connections refer to any suitable connections between computers such as, for example, intranets, local area networks (LAN), virtual private networks (VPN), wireless area networks (WAN) and the internet among others. Memory 308 includes a random access memory (RAM) or another type of dynamic storage device 310 which may store information and instructions for execution by central processing unit (CPU) 312. Storage device 310 includes a magnetic and/or optical recording medium such as read-only memory, flash memory, ferroelectric RAM (F-RAM) hard disks, floppy disks, and optical discs, among others. Central processing unit (CPU) 312 includes a microprocessor, an application specific integrated circuit (ASIC), or field programmable object array (FPOA), among others, which may interpret and execute instructions.

Software instructions are read into memory 308 from another computer-readable medium, such as storage device 310, or from another client computing device 300 via interface 306. The software instructions contained in memory 308 cause central processing unit (CPU) 312 to perform one or more processes described herein. Alternatively, hardwired circuitry is used in place of or in combination with software instructions to implement processes described herein. Thus, implementations described herein are not limited to any specific combination of hardware circuitry and software.

Biometrics capture device 314 may include 2D face, 3D face, hand geometry, single fingerprint, ten finger live scan, iris, palm, full hand, signature, ear, finger vein, retina, DNA and/or voice capture devices, or any subset thereof. Biometrics capture device 314 also includes a client SDK that may collect and format biometric data captured for transmission to the identity provider 204 or/and biometric engine 100.

In other embodiments, biometric capture device 314 is implemented in a separate module that can be plugged into client computing device 300. For example, biometric capture device 314 can be a dedicated camera, microphone, fingerprint scanner station that can be connected to client computing device 300 for capturing one or more biometric probes.

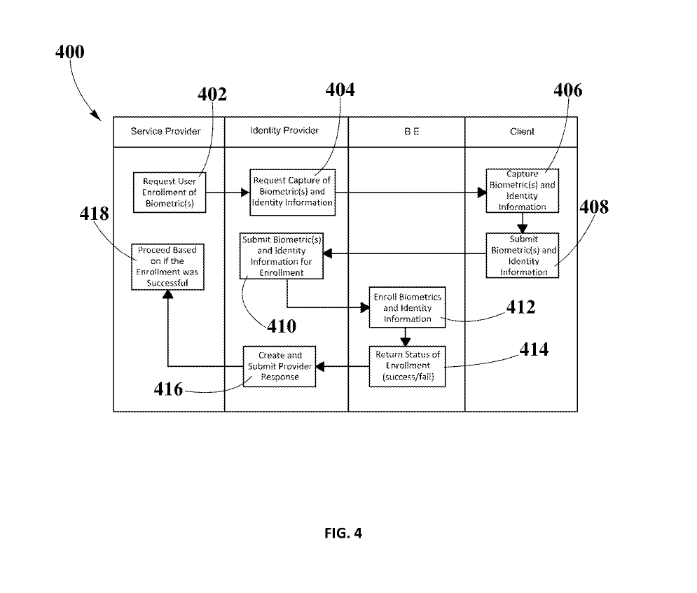

FIG. 4 illustrates a method of cloud-based biometric enrollment 400 that is executed by a system according to embodiments described herein.

Cloud-based biometric enrollment 400 starts at step 402 where a service provider requests client enrollment of one or more biometrics and client identity information, which may be later used for biometric identification and/or verification. A service provider can be an online retailer, a cloud-based application, an online banking website, a webpage, a store, or a company requesting client enrollment, among others. More specifically, the service provider requests client enrollment of biometrics and client identity information through a computer interface executed in a variety of client computing devices, such as laptops computers, desktop computers, PDA's, and the like.

Afterwards, at step 404, an identity provider requests the capturing of one or more biometrics and client identity information. According to an embodiment, client identity information includes username and password, and/or demographic information such as phone number, address, and name, among others. Depending on environment conditions, demographics, geographic location and client preferences, among other factors, identity provider may request the capture of specific biometric information and/or all the biometric information available.

Subsequently, at step 406, client computing devices employ embedded and/or externally attached hardware for capturing biometric probes. The client computing device allows the client to submit biometric probes such as fingerprints, iris scans, face scans, and voice patterns, among others. In addition, computer interface assists the client to select biometric probes to be enrolled and guides the client during the process of enrollment. Client computing device also requests client identity for associating the biometric probes with the corresponding client. In this case, the client inputs the client identity information through the input interface of the client computing device.

After capturing biometric probes and identity information at step 406, client computing devices submits the captured biometric probes and client identity information to the identity provider, at step 408.

Subsequently, at step 410, identity provider submits the captured biometric probes and client identity information to a biometric engine for enrollment.

Afterwards, at step 412, the biometric engine enrolls biometrics probes and client identity information. During this step, query router stores the client identity information in the demographic database and sends the captured biometric probes to corresponding query engine. Each query engine converts the biometric probes into biometric templates and may have an associated biometric data cache. In an embodiment of the invention, a template data manager is included that manages a biometric engine's biometric data cache where biometric templates are stored and retrieved. Query engine communicates with query router and moves biometric templates into and out of biometric data cache. Query engine also supports one or more biometric data caches.

Subsequently, at step 414 the query router monitors the activities of the query engine and sends a Service-Oriented Architecture (SOA) response back to the identity provider indicating a failed or successful enrollment of biometric client.

Then, at step 416, identity provider creates and submits a response regarding the status of biometric enrollment. Subsequently, at step 418 if the enrollment was successful, service provider proceeds to verify and/or identify client through biometrics probes for a subsequent transaction. Finally, cloud-based biometric enrollment 400 may end.

### EXAMPLE

Example #1 describes a cloud-based biometric enrollment process for a client employing biometric authentication system during a bank transaction. In this example, a commercial bank previously has stored client identity information about the client such as a name, last name, email address, password and/or any other specific information to create an account for the user. A Bank cloud-based application may first require ID credentials, such user name and password, or personal information to verify his/her identity. Once the client has provided the required information, biometric engine in cloud biometric authentication may execute query router to verify client identity information, which is previously stored in a demographic database. When the client's identity is confirmed, bank cloud-based application requests one or more biometric probes. Biometric probes are captured through embedded hardware in client computing devices. In this example, a fingerprint reader is used for capturing biometric probes from client's fingerprints. The client, query engine, or biometric engine converts the associated biometric probe into a biometric template. Query engine stores template in the corresponding biometric data cache. As a result, when the client tries to log in for a second time to the bank cloud-based application, the biometric authentication system requests the submission of a biometric probe that is compared against the biometric templates stored during the biometric enrollment process described herein.

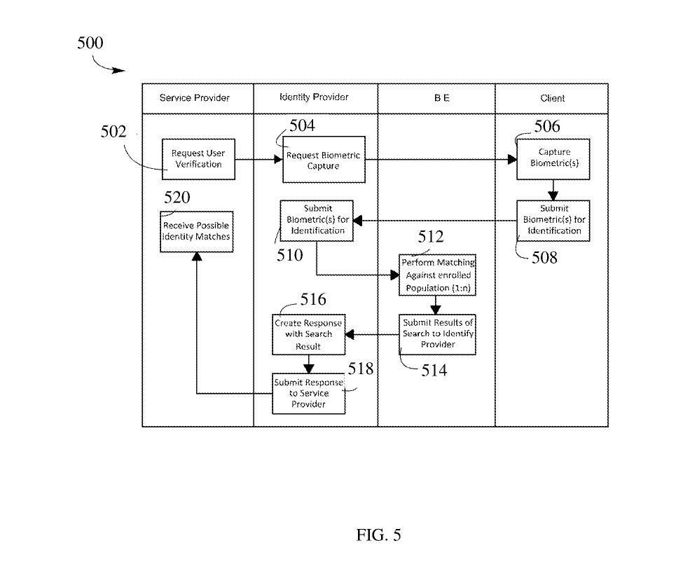

FIG. 5 illustrates a method for cloud-based biometric identification 500 that may be performed in a system according to embodiments described herein.

Biometric identification 500 starts at step 502, where a service provider requests the identification of one or more clients in order to allow access to the services offered by the aforementioned service provider, or to approve an offline or online transaction through the service provider. A service provider can be an online retailer, a cloud-based application, an online banking website, a webpage, a store, a border control agency, a public safety institution, a hospital or a service company requiring the identification of client 202. More specifically, the service provider requests the identification of one or more clients to an identity provider.

In one or more embodiments, the service provider requests the client to provide an identifier such as username and password, and/or demographic information such as phone number, address, name, among others.

The identity provider requests one or more biometric captures at step 504. The aforementioned biometric captures may include images of biometric features such as 2D face, 3D face, hand geometry, single fingerprint, ten finger live scan, iris, palm, full hand, signature, ear, finger vein, retina, DNA, voice, or any subset thereof. Afterwards, a client computing device, which supports multimodal biometric capturing, may capture the one or more biometric probes at step 506.

The client computing device submits the required one or more biometric probes to the identity provider at step 508. The identity provider allows the exchange of information between the service provider and the biometric engine. For identification purposes, identity provider submits the one or more biometric probes to a biometric engine at step 510.

In step 512, the biometric engine performs a matching of the one or more biometric probes against biometric templates of an enrolled population. The biometric templates are stored in biometric data caches for providing a faster client identification.

In an embodiment of the invention, a query router operating within a biometric engine may distribute the biometric probes to one or more query engines also operating within the biometric engine. The one or more query engine in conjunction with a template data manager within the biometric engine then converts the biometric probes into biometric templates for comparison against previously stored biometric templates in one or more biometric data caches within biometric engine. The result of the comparison is a biometric score which represents a probability of identity where it may be assumed that both the biometric probe and the previously stored biometric template correspond to the same client. The one or more query engines determine if the biometric scores generated meet a minimum threshold score. If it is determined that the biometric score meets the minimum threshold score, then the biometric score with associated ID credentials may be added into a list of possible matches. In case the biometric score does not meet the minimum threshold score, then the query engine may move on to the next candidate in the queue. This process may continue until there are no more candidates in the queue.

Afterwards, the biometric engine submits the search results to the identity provider at step 514. Then, the identity provider creates a response based on the aforementioned search results at step 516. The identity provider submits the response to the service provider at step 518. In one or more embodiments the response includes the list of possible matches sorted by the probability of identity. Finally, the service provider receives the possible identity matches at step 520.

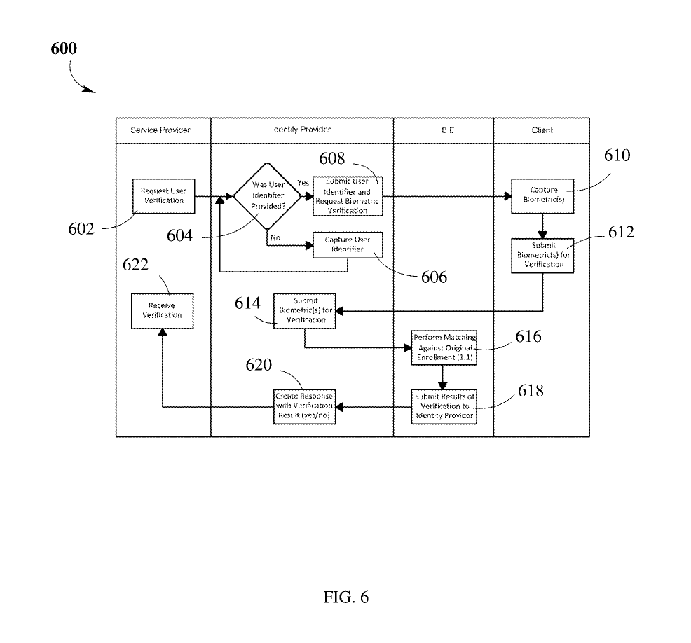

FIG. 6 illustrates a cloud biometric verification method 600 that may be performed in a system according to embodiments described herein. Verification method 600 starts at step 602 where a service provider requests the verification of one or more clients in order to allow access to the services offered by the service provider, or to approve an offline or online transaction through the service provider. A service provider can be, for example, an online retailer, a cloud-based application, an online banking website, a webpage, a store, or a company requesting client verification. More specifically, the service provider requests client verification to an identity provider which is implemented through an authentication module configured in the cloud or a suitable network. The identity provider maintains and manages identity information for clients and provides authentication to other service providers.

The identity provider checks if the identifier for the client is already provided, at step 604. The client identifier includes login credentials such as username and password, or includes demographic information such as phone number, address, name, and the like. For example, in order to obtain the client identifier, the identity provider checks the cookies at the client computing device used by the client to log in or access the service provider.

If the client is not logged in to or has not logged in to the service provider, or has not accessed the service provider, then the identity provider requests the client identifier, at step 606. In this case, the client submits username and password (optional) for allowing the identity provider to capture the corresponding client identifier.

If the client identifier is provided, then the identity provider verifies the supplied or captured client identifier against in its database of client identifiers, and then submits the corresponding identifier back to the service provider, at step 608. In addition, the identity provider requests the biometric verification of the client associated with the captured or submitted identifier.

The identity provider sends a request for client biometric verification to the service provider, at step 610, where one or more client biometric probes are captured through one or more client computing devices capable of supporting multimodal biometric authentication.

The client computing device submits one or more biometric probes of the client to the identity provider which allows the exchange of authentication data between the service provider and a biometric engine, at step 612. Subsequently, at step 614, the identity provider submits the captured client biometric probes to the biometric engine for verification.

The biometric engine performs the verification of one or more biometric probes submitted by the identity provider, at step 616. During biometric verification, a query router within the biometric engine distributes the biometric probes to the appropriate query engines also within the biometric engine. One or more query engines in conjunction with a template data manager within the biometric engine then converts said biometric probes into biometric templates for comparison against biometric templates previously stored in one or more biometric data caches within biometric engine. The result of the comparison is a biometric score which represents a probability that the biometric probe captured is from the same client as the biometric template it is being compared against.

The query engine then returns the generated biometric score to the query router which may send a SOA response to the identity provider indicating a successful or failed matching, at step 618.

Subsequently at step 620, the identity provider generates a response with the result of the biometric verification performed by the biometric engine, where this generated response confirms a successful or failed biometric verification of the client. Finally, at step 622, the identity provider sends the response to the service provider with the biometric verification of the client. A successful verification of the client may allow access to the services provided by the service provider, or it may approve the transaction requested by the client through the service provider.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

The foregoing method descriptions and the interface configuration are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined here may be applied to other embodiments without departing from the spirit or scope of the invention. Thus, the present invention is not intended to be limited to the embodiments shown here but is to be accorded the widest scope consistent with the following claims and the principles and novel features disclosed here.

I claim:

1. A cloud-based biometric authentication infrastructure system comprising:
a plurality of clients in communication with a service provider through a client computing device;
a service provider configured to request the biometric identification of said clients over a network connection;
an identity provider configured to use one or more open authentication protocols to enable cloud communications between the service provider and a plurality of biometric engines responsible for performing biometric identification;
wherein the client computing device captures one or more biometric probes from the client and submits them for identification to the identity provider;
wherein the identity provider submits the one or more biometric probes to the biometric engine which perform a matching of the one or more biometric probes against biometric templates stored in the system;
wherein the results of the matching are communicated to the service provider through the identity provider.

2. The system of claim 1, wherein the one or more biometrics are different biometrics.

3. The system of claim 2, wherein the results of the matching comprise a biometric fusion score.

4. The system of claim 1, wherein the one or more authentication protocols is SAML.

5. The system of claim 1, wherein the one or more authentication protocols is OpenID.

6. The system of claim 1, wherein the client computing device is a mobile device.

7. The system of claim 1, wherein biometric templates stored in the system are from an enrolled population.

8. The system of claim 7, wherein the service provider receives the possible identity matches from the identity provider.

9. The system of claim 1, wherein result of the matching represents a probability that the biometric probe captured is from the same client as the biometric template it is being compared against.

10. A method of cloud-based biometric authentication, the method comprising the steps of:
communicating with a service provider through a client computing device;
requesting the biometric identification of said clients through the service provider;
capturing one or more biometric probes from the client:
submitting the one or more biometric probes for identification to the identity provider using one or more open authentication protocols;
forwarding the one or more biometric probes from the identity provider to the biometric engine using one or more open authentication protocols;
matching the one or more biometric probes against biometric templates available to the biometric engine;
communicating the results of the matching to the service provider through the identity provider.

11. The method of claim 10, wherein the one or more biometric probes are different biometrics.

12. The method of claim 11, wherein the results of the matching comprise a biometric fusion score.

13. The method of claim 10, wherein the one or more authentication protocols is SAML.

14. The method of claim 10, wherein the one or more authentication protocols is OpenID.

15. The method of claim 10, wherein the client computing device is a mobile device.

16. A cloud-based biometric enrollment infrastructure system comprising:
a plurality of clients in communication with a service provider through a client computing device;
a service provider configured to request the biometric enrollment of said clients over a network connection;
an identity provider configured to use one or more open authentication protocols to enable cloud communications between the service provider and a plurality of biometric engines responsible for performing biometric enrollment;
wherein the client computing device captures one or more biometric probes from the client and submits them for enrollment with the identity provider;
wherein the identity provider submits the one or more biometric probes to the biometric engine which generates and stores one or more biometric templates generated from the one or more biometric probes; and
wherein the identity provider creates and submits a response regarding the status of biometric enrollment.

17. The system of claim 16, wherein the one or more biometrics are different biometrics.

18. The system of claim 16, wherein the one or more authentication protocols is SAML.

19. The system of claim 16, wherein the one or more authentication protocols is OpenID.

20. The system of claim 16, wherein the client computing device is a mobile device.
